(19) United States
(12) Patent Application Publication
(10) Pub. No.: US 2022/0180787 A1
(43) Pub. Date: Jun. 9, 2022

(54) DISPLAY DRIVING APPARATUS AND DISPLAY DRIVING METHOD

(71) Applicant: LX SEMICON CO., LTD., Daejeon (KR)

(72) Inventors: Jong Suk LEE, Daejeon (KR); Young Bok KIM, Daejeon (KR)

(21) Appl. No.: 17/540,384

(22) Filed: Dec. 2, 2021

(30) Foreign Application Priority Data
Dec. 3, 2020 (KR) 10-2020-0167424

(51) Int. Cl. G09G 3/20; H01Q 1/24; H01Q 1/38

(52) U.S. Cl. CPC G09G 3/20; H01Q 1/248; H01Q 1/38; G09G 2310/08; G09G 2330/023; G09G 2320/041; G09G 2300/0408

(57) ABSTRACT

There is disclosed a display driving apparatus configured to drive a display device for displaying an image, including a source driver IC configured to convert image data into a source signal, and an energy harvesting apparatus configured to convert thermal energy generated in the source driver IC and radio frequency (RF) energy into electrical energy and supply the electrical energy to the source driver IC, wherein the energy harvesting apparatus includes a first energy converter configured to convert the thermal energy generated in the source driver IC into the electrical energy to output a first energy harvesting current, and a second energy converter configured to convert the RF energy into the electrical energy to output a second energy harvesting current, and an energy storage configured to receive the first energy harvesting current and the second energy harvesting current from the first energy converter and the second energy converter, respectively.

### CROSS-REFERENCE TO RELATED APPLICATIONS

This application claims the benefit of the Korean Patent Applications No. 10-2020-0167424 filed on Dec. 3, 2020 which is hereby incorporated by reference as if fully set forth herein.

### FIELD

The present specification relates to a display driving apparatus and a display driving method.

### BACKGROUND

Representative examples of a display device for displaying an image include a liquid crystal display (LCD) using liquid crystals, an organic light-emitting diode (OLED) display using an OLED, and the like. A technique for reducing the power consumption of the display device has been developed.

However, it is difficult to reduce power essentially consumed to perform each function in a display panel and a display driving apparatus constituting the display device.

### SUMMARY

The present disclosure is directed to providing a display driving apparatus and a display driving method allowing power consumed in the display driving apparatus to be reduced using an energy harvesting apparatus.

According to an aspect of the present disclosure, there is provided a display driving apparatus configured to drive a display device for displaying an image, including a source driver integrated circuit (IC) configured to convert image data into a source signal, and an energy harvesting apparatus configured to convert thermal energy generated in the source driver IC and radio frequency (RF) energy into electrical energy and supply the electrical energy to the source driver IC, wherein the energy harvesting apparatus includes a first energy converter configured to convert the thermal energy generated in the source driver IC into the electrical energy to output a first energy harvesting current, and a second energy converter configured to convert the RF energy into the electrical energy to output a second energy harvesting current, and an energy storage configured to receive the first energy harvesting current and the second energy harvesting current from the first energy converter and the second energy converter, respectively, and store power to output a first auxiliary voltage that is a voltage generated due to the stored power, wherein the first energy converter, the second energy converter, and the energy storage are located on the source driver IC.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a diagram illustrating a configuration of a display device including a display driving apparatus according to one embodiment of the present disclosure;

FIG. 2 is a diagram illustrating a configuration of an energy harvesting apparatus according to one embodiment of the present disclosure;

FIG. 3 is a view illustrating a structure of a source driver integrated circuit (IC) and the energy harvesting apparatus according to one embodiment of the present disclosure;

FIG. 4A is a view schematically illustrating a structure of a first energy converter according to one embodiment of the present disclosure;

FIG. 4B is a view illustrating a structure of a thermoelectric module according to one embodiment of the present disclosure;

FIG. 5 is a view schematically illustrating a structure of an antenna part of a second energy converter according to one embodiment of the present disclosure;

FIG. 6 is a diagram illustrating a circuit structure of an RF-to-direct current (RF-DC) rectifier circuit part according to one embodiment of the present disclosure;

FIG. 7 is a graph illustrating a relationship between a current input to an energy storage and a voltage output from the energy storage according to one embodiment of the present disclosure; and

FIG. 8 is a flowchart illustrating an energy harvesting process of the energy harvesting apparatus and the display driving apparatus according to one embodiment of the present disclosure.

### DETAILED DESCRIPTION

In the specification, it should be noted that like reference numerals already used to denote like elements in other drawings are used for elements wherever possible. In the following description, when a function and a configuration known to those skilled in the art are irrelevant to the essential configuration of the present disclosure, their detailed descriptions will be omitted. The terms described in the specification should be understood as follows.

Advantages and features of the present disclosure, and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Further, the present disclosure is only defined by scopes of claims.

A shape, a size, a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted.

In a case where ‘comprise’, ‘have’, and ‘include’ described in the present specification are used, another part may be added unless ‘only˜’ is used. The terms of a singular form may include plural forms unless referred to the contrary.

In construing an element, the element is construed as including an error range although there is no explicit description.

In describing a time relationship, for example, when the temporal order is described as ‘after˜’, ‘subsequent˜’, ‘next˜’, and ‘before˜’, a case which is not continuous may be included unless ‘just’ or ‘direct’ is used.

It will be understood that, although the terms “first”, “second”, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item.

Features of various embodiments of the present disclosure may be partially or overall coupled to or combined with each other, and may be variously inter-operated with each other and driven technically as those skilled in the art can sufficiently understand. The embodiments of the present disclosure may be carried out independently from each other, or may be carried out together in co-dependent relationship.

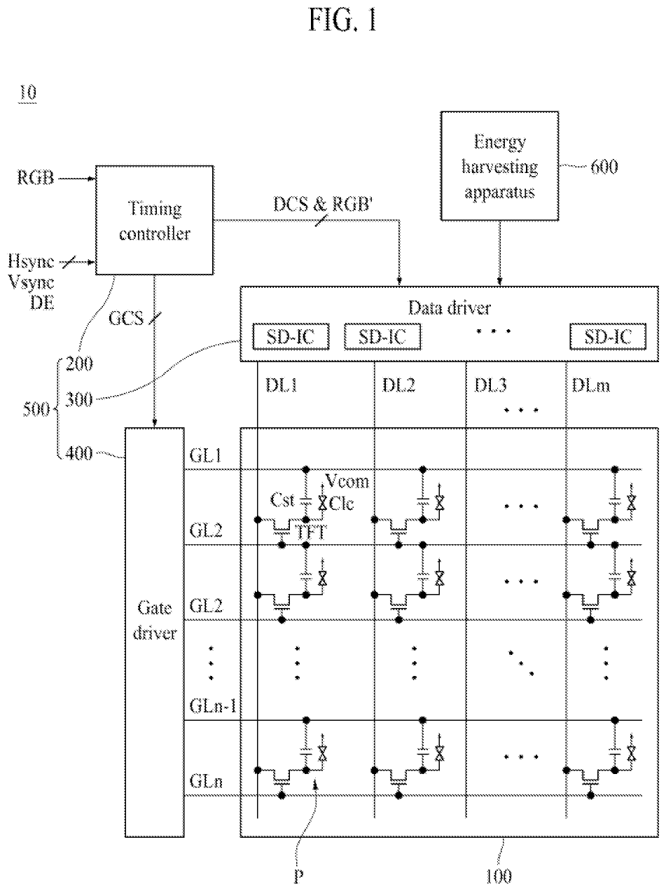

Hereinafter, a display device including a display driving apparatus according to an embodiment of the present disclosure will be described in detail with reference to FIG. 1.

FIG. 1 is a diagram illustrating a configuration of a display device including a display driving apparatus according to one embodiment of the present disclosure. As shown in FIG. 1, a display device 10 includes a display panel 100 and a display driving apparatus 500, and the display driving apparatus 500 includes a timing controller 200, a data driver 300, a gate driver 400, and an energy harvesting apparatus 600.

The display panel 100 includes a plurality of gate lines GL1 to GLn and a plurality of data lines DL1 to DLm, which are arranged to intersect each other and define a plurality of pixel regions, and a pixel P provided in each of the plurality of pixel regions. The plurality of gate lines GL1 to GLn may be arranged in a transverse direction and the plurality of data lines DL1 to DLm may be arranged in a longitudinal direction, but the present disclosure is not necessarily limited thereto.

The display panel 100 may be a liquid crystal display (LCD) panel. When the display panel 100 is an LCD panel, the display panel 100 includes thin-film transistors (TFTs) and liquid crystal cells connected to the TFTs, which are formed in the pixel regions defined by the plurality of gate lines GL1 to GLn and the plurality of data lines DL1 to DLm.

The TFT transmits a data signal supplied through the data lines DL1 to DLm to the liquid crystal cell in response to a scan pulse supplied through the gate lines GL1 to GLn.

The liquid crystal cell is composed of a common electrode and a sub-pixel electrode, which is connected to the TFT, facing each other with a liquid crystal therebetween, and thus may be equivalently expressed as a liquid crystal capacitor Clc. The liquid crystal cell includes a storage capacitor Cst connected to the gate line of a previous stage in order to maintain a voltage corresponding to a source signal charged in the liquid crystal capacitor Clc until a voltage corresponding to a next source signal is charged.

Meanwhile, the pixel regions of the display panel 100 may include red (R), green (G), blue (B), and white (W) subpixels. Each of the subpixels may be repeatedly formed in a row direction or formed in a matrix form of 2×2. In this case, a color filter corresponding to each color is disposed in each of the red (R), green (G), and blue (B) subpixels, but a separate color filter is not disposed in the white (W) subpixel. The red (R), green (G), blue (B), and white (W) subpixels may be formed to have the same area ratio, but may also be formed to have different area ratios.

Although the display panel 100 is described as being an LCD panel, the display panel 100 may be an organic light-emitting diode (OLED) display panel in which an OLED is formed in each pixel region.

The timing controller 200 receives various timing signals including a vertical synchronization signal Vsync, a horizontal synchronization signal Hsync, a data enable signal DE, a clock signal CLK, and the like from an external system (not shown), and generates a data control signal DCS for controlling the data driver 300 and a gate control signal GCS for controlling the gate driver 400. In addition, the timing controller 200 receives an image data RGB from the external system, converts the received image data RGB into an image data RGB′ in a form that can be processed by the data driver 300, and outputs the converted image data RGB′.

The data driver 300 converts the aligned image data RGB′ into a source signal according to the data control signal DCS generated by the timing controller 200. The data control signal DCS may include a source start pulse SSP, a source sampling clock SSC, a source output enable signal SOE, and the like. Here, the source start pulse controls a data sampling start timing of a signal converter. The source sampling clock is a clock signal which controls a sampling timing of data in each of source driver integrated circuits (ICs). The source output enable signal controls an output timing of the signal converter of each of the source driver ICs. That is, the data driver 300 converts the aligned image data RGB′ into the source signal according to the source start pulse, the source sampling clock, and the source output enable signal, and outputs the source signals corresponding to one horizontal line to the data lines every one horizontal period at which the gate signals are supplied to the gate lines. Here, the signal converter may receive a gamma voltage from a gamma voltage generator (not shown) and convert the aligned image data RGB′ into the source signal using the gamma voltage. To this end, the data driver 300 includes n source driver ICs SD-IC.

The gate driver 400 outputs the gate signals, which are synchronized with the source signals generated by the data driver 300, to the gate lines in response to the gate control signal GCS generated by the timing controller 200. The gate control signal GCS may include a gate start pulse GSP, a gate shift clock GSC, a gate output enable signal, and the like. Here, the gate start pulse controls an operation start timing of m gate driver ICs (not shown) that configure the gate driver 400. The gate shift clock is a clock signal which is commonly input to one or more gate driver ICs and controls a shift timing of a scan signal (gate pulse). The gate output enable signal designates timing information of one or more gate driver ICs.

The gate driver 400 includes a gate shift register circuit, a gate level shifter circuit, and the like. In this case, the gate shift register circuit may be formed directly on a TFT array substrate of the display panel 100 by a gate-in-panel (GIP) process. In this case, the gate driver 400 supplies the gate start pulse and the gate shift clock signal to the gate shift register circuit that is formed on the TFT array substrate by a GIP process.

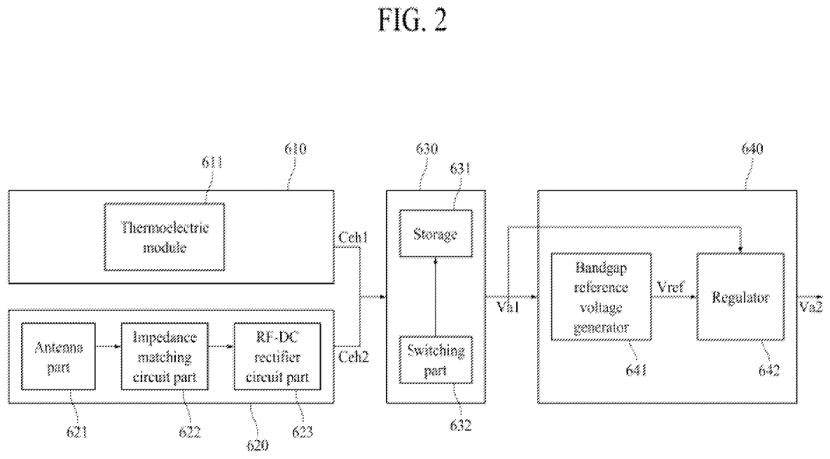

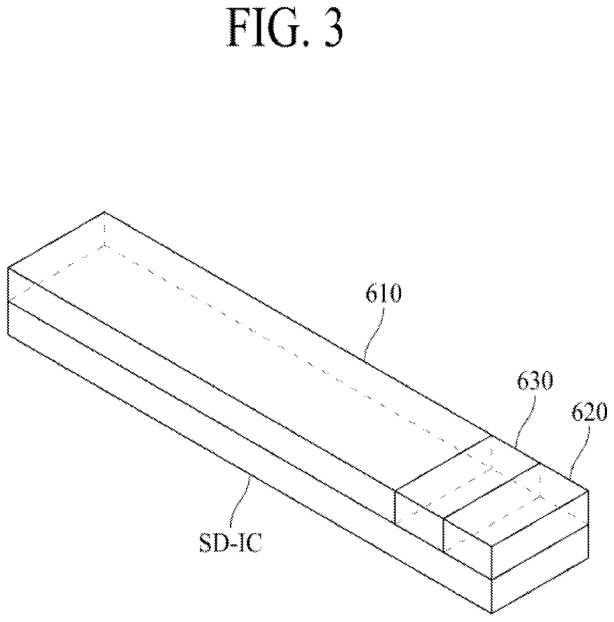

According to one embodiment of the present disclosure, the energy harvesting apparatus 600 converts ambient thermal energy and radio frequency (RF) energy into electrical energy and supplies the electrical energy to the data driver 300. The energy harvesting apparatus 600 includes a first energy converter 610, a second energy converter 620, an energy storage 630, and a voltage stabilizer 640. The energy harvesting apparatus 600 according to one embodiment of the present disclosure will be described below in detail with reference to FIGS. 2 and 3.

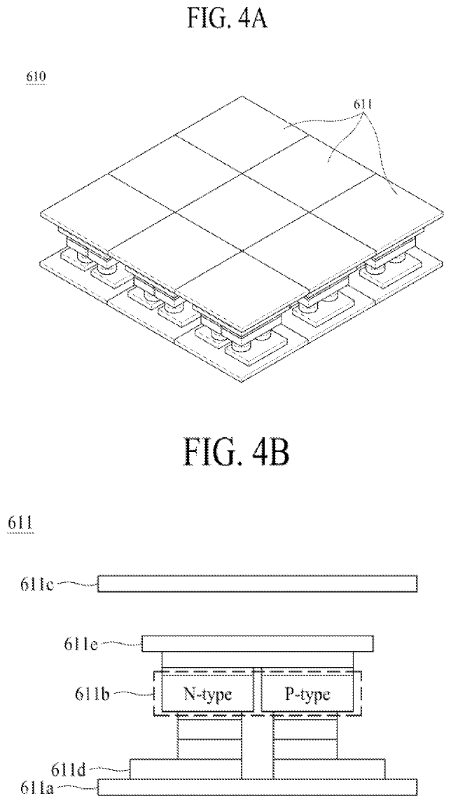

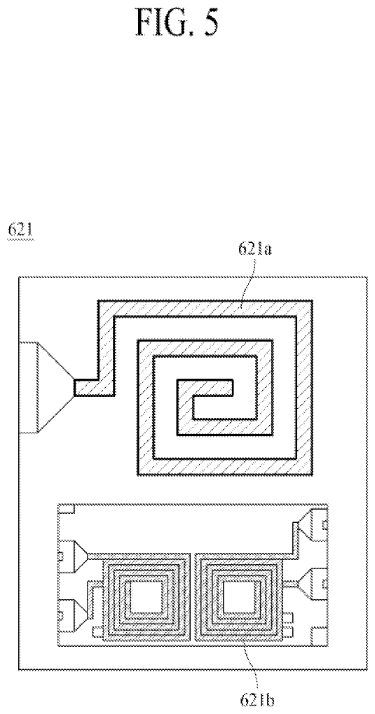

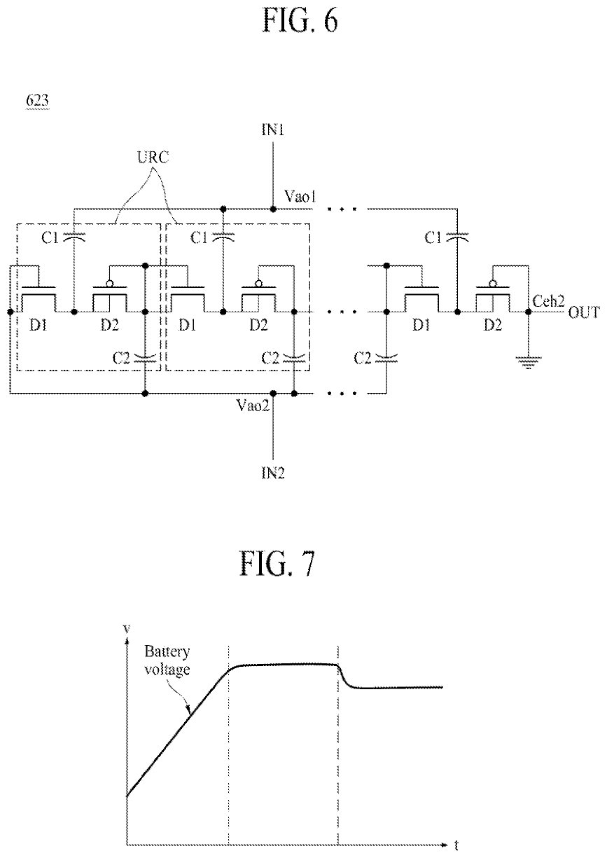

Hereinafter, the energy harvesting apparatus according to the present disclosure will be described in detail with reference to FIGS. 2 to 7. FIG. 2 is a diagram illustrating a configuration of the energy harvesting apparatus according to one embodiment of the present disclosure, and FIG. 3 is a view illustrating a structure of the source driver IC and the energy harvesting apparatus according to one embodiment of the present disclosure. FIG. 4A is a view schematically illustrating the first energy converter according to one embodiment of the present disclosure, and FIG. 4B is a view illustrating a structure of a thermoelectric module according to one embodiment of the present disclosure. FIG. 5 is a view schematically illustrating a structure of an antenna part of the second energy converter according to one embodiment of the present disclosure, FIG. 6 is a diagram illustrating a circuit structure of an RF-to-direct current (RF-DC) rectifier circuit part according to one embodiment of the present disclosure, and FIG. 7 is a graph illustrating a relationship between a current input to the energy storage and a voltage output from the energy storage according to one embodiment of the present disclosure.

As described above, the energy harvesting apparatus 600 converts thermal energy and RF energy generated from the surroundings into electrical energy, and outputs the converted electrical energy.

As shown in FIG. 2, the energy harvesting apparatus 600 according to one embodiment of the present disclosure includes the first energy converter 610, the second energy converter 620, the energy storage 630, and the voltage stabilizer 640.

According to one embodiment of the present disclosure, as shown in FIG. 3, the first energy converter 610, the second energy converter 620, and the energy storage 630 are disposed on the source driver IC SD-IC in the form of a film and may be integrally configured with the source driver IC SD-IC. To this end, each of the first energy converter 610, the second energy converter 620, and the energy storage 630 may have a smaller area than the source driver IC SD-IC. Specifically, each of the first energy converter 610, the second energy converter 620, and the energy storage 630 may have a width less than or equal to that of the source driver IC SD-IC, and may have a length less than that of the source driver IC SD-IC.

The first energy converter 610 converts thermal energy into electrical energy and outputs the electrical energy. Specifically, the first energy converter 610 absorbs thermal energy generated in the source driver IC SD-IC and converts the absorbed thermal energy to output a first energy harvesting current Ceh1. At this point, the first energy converter 610 according to one embodiment of the present disclosure may be disposed to be in contact with the source driver IC SD-IC to effectively absorb the thermal energy generated in the source driver IC SD-IC.

According to one embodiment of the present disclosure, since the first energy converter 610 is directly connected to the energy storage 630 to be described below, the first energy harvesting current Ceh1, which does not pass through a separate rectifier circuit, is directly output to the energy storage 630.

As shown in FIG. 4A, the first energy converter 610 includes a plurality of thermoelectric modules 611 configured to convert thermal energy generated in the source driver IC SD-IC into electrical energy. The plurality of thermoelectric modules 611 may be arranged in the form of a matrix of n×m (where n and m are positive integers), and may be disposed on the source driver IC SD-IC in the form of a film.

According to one embodiment of the present disclosure, as shown in FIG. 3, the first energy converter 610 has a smaller area than the source driver IC SD-IC, and may be integrally configured with the source driver IC SD-IC on the source driver IC SD-IC. For example, the first energy converter 610 may have a width less than or equal to that of the source driver IC SD-IC, and may have a length less than that of the source driver IC SD-IC. Accordingly, the area and volume occupied by the source driver IC SD-IC and the energy harvesting apparatus 600 may be minimized.

Referring to FIG. 4B, the thermoelectric module 611 may include a first substrate 611a configured to absorb heat, a unit cell 611b including a P-type semiconductor and an N-type semiconductor, a second substrate 611c disposed opposite to the first substrate 611a, a first electrode 611d disposed between the first substrate 611a and the unit cell 611b, and a second electrode 611e disposed between the second substrate 611c and the unit cell 611b. The P-type semiconductor is a P-type thermoelectric semiconductor that allows holes to move so that thermal energy is transferred, and the N-type semiconductor is an N-type thermoelectric semiconductor that allows electrons to move so that thermal energy is transferred. In addition, the thermoelectric module 611 may further include a dielectric layer located between the first electrode 611d and the unit cell 611b, and between the unit cell 611b and the second electrode 611e. However, the thermoelectric module 611 is not limited thereto and may include a material or structure for converting thermal energy into electrical energy.

The second energy converter 620 collects ambient RF energy, converts the collected RF energy into electrical energy, and outputs the electrical energy. Specifically, the second energy converter 620 collects ambient RF energy, and converts the collected RF energy to output a second energy harvesting current Ceh2. According to one embodiment of the present disclosure, since the second energy converter 620 is directly connected to the energy storage 630 to be described below, the second energy harvesting current Ceh2, which does not pass through a separate rectifier circuit, is directly output to the energy storage 630.

The second energy converter 620 includes an antenna part 621, an impedance matching circuit part 622, and an RF-DC rectifier circuit part 623.

The antenna part 621 collects RF energy generated due to external electromagnetic radiation in the ambient environment and generates an antenna output voltage corresponding to the collected RF energy. At this point, the antenna output voltage is an alternating current (AC) voltage.

The antenna part 621 may include a plurality of antennas for collecting RF energy of different frequencies to increase the total amount of RF energy collected by the antenna part 621. The antenna part 621 may include a plurality of antennas each for collecting RF energy corresponding to each frequency band. Each of the antennas may have a smaller area as a receiving frequency band increases. For example, the antenna part 621 may include a first antenna 621a configured to collect RF energy of a frequency band of 1.1 GHz and a second antenna 621b configured to collect RF energy of a frequency band of 1.8 GHz, and the first antenna 621a may have a larger area than the second antenna 621b.

According to one embodiment of the present disclosure, the antenna part 621 of the second energy converter 620 may be disposed on the source driver IC SD-IC in the form of a film. Accordingly, the area and volume of the energy harvesting apparatus 600 configured to supply electrical energy to the source driver IC SD-IC may be reduced so that the source driver IC SD-IC and the energy harvesting apparatus 600 may be light in weight.

The impedance matching circuit part 622 allows the impedance of the antenna part 621 to be matched to that of the RF-DC rectifier circuit part 623, thereby improving the reception efficiency of the RF energy collected by the antenna part 621.

The RF-DC rectifier circuit part 623 rectifies an impedance-matched antenna output voltage to output the second energy harvesting current Ceh2 to the energy storage 630. Specifically, the RF-DC rectifier circuit part 623 receives and rectifies a first antenna output voltage, which is the antenna output voltage output from the antenna part 621, and a second antenna output voltage, which is an inverted voltage of the antenna output voltage, to output the second energy harvesting current Ceh2. For example, as shown in FIG. 6, the RF-DC rectifier circuit part 623 receives a first antenna output voltage Vao1 through a first input terminal IN1 and receives a second antenna output voltage Vao2 through a second input terminal IN2, and rectifies the received first and second antenna output voltages Vao1 and Vao2 to output the second energy harvesting current Ceh2.

The RF-DC rectifier circuit part 623 according to one embodiment of the present disclosure receives the first antenna output voltage Vao1, which is the antenna output voltage, and the second antenna output voltage Vao2, which is a voltage inverted from the antenna output voltage, and thus does not include a separate oscillator including a clock.

The RF-DC rectifier circuit part 623 according to one embodiment of the present disclosure rectifies the antenna output voltage using a plurality of diodes D1 and D2 and a plurality of capacitors C1 and C2. Specifically, the RF-DC rectifier circuit part 623 includes one or more unit rectifier circuits URC each including a first diode D1, which is an N-type metal-oxide-semiconductor (NMOS) transistor, a second diode D2, which is a P-type metal-oxide-semiconductor (PMOS transistor), a first capacitor C1 connected to an output terminal of the first diode D1, and a second capacitor C2 connected to an output terminal of the second diode D2, and may be configured by linearly connecting a plurality of unit rectifier circuits URC. Accordingly, the RF-DC rectifier circuit part 623 receives and rectifies the first antenna output voltage Vao1 and second antenna output voltage Vao2 through the one or more unit rectifier circuits URC constituting the RF-DC rectifier circuit part 623 to output the second energy harvesting current Ceh2.

Specifically, the RF-DC rectifier circuit part 623 includes the first input terminal IN1 through which the first antenna output voltage Vao1 is received, the second input terminal IN2, through which the second antenna output voltage Vao2 is received, the above-described one or more unit rectifier circuits URC, and an output terminal OUT connected to the one or more unit rectifier circuits URC and through which the second energy harvesting current Ceh2 is output. At this point, as shown in FIG. 6, the first input terminal IN1 is connected to the output terminal of the first diode D1 and an input terminal of the second diode D2 through the first capacitor C1, and the second input terminal IN2 is connected to an input terminal and a control terminal of the first diode D1 and connected to the output terminal and a control terminal of the second diode D2 through the second capacitor C2.

The RF-DC rectifier circuit part 623 according to one embodiment of the present disclosure includes the first diode D1, which is an NMOS transistor having a high threshold voltage and low turn-on resistance, and the second diode D2, which is a PMOS transistor having a low threshold voltage and high turn-on resistance, and thus, outputs a stable and high voltage as compared to a rectifier circuit configured with only the NMOS transistor and a rectifier circuit configured with only the PMOS transistor.

The energy storage 630 receives the first energy harvesting current Ceh1 and the second energy harvesting current Ceh2, and accordingly, when a first auxiliary voltage Va1, which is a voltage generated due to power stored in the energy storage 630, is greater than or equal to a usable voltage, the first auxiliary voltage Va1 is output to the voltage stabilizer 640.

As shown in FIG. 7, as the current is input to the energy storage 630, the amount of the power stored in the energy storage 630 increases to increase the first auxiliary voltage Va1, which is a voltage generated due to the power stored in the energy storage 630. At this point, when the amount of the power corresponding to a voltage greater than or equal to a predetermined voltage is stored in the energy storage 630, the first auxiliary voltage Va1, which is generated due to the power stored in the energy storage 630, does not increase further and maintains a constant value. That is, as the first energy harvesting current Ceh1 and the second energy harvesting current Ceh2 are input to the energy storage 630, the amount of the power stored in the energy storage 630 increases to increase the first auxiliary voltage Va1 generated due to the stored power, and when the first auxiliary voltage Va1 is greater than or equal to the usable voltage, the energy storage 630 outputs the first auxiliary voltage Va1.

According to one embodiment of the present disclosure, the energy storage 630 is disposed on the source driver IC SD-IC in the form of a film. As such, the energy storage 630 may be integrally configured with the source driver IC SD-IC so that the area and volume occupied by the energy storage 630 may be reduced.

Since the energy harvesting apparatus 600 according to one embodiment of the present disclosure includes the RF-DC rectifier circuit part 623, the energy storage 630 is directly connected to the first energy converter 610 and the second energy converter 620. Accordingly, since the energy storage 630 directly receives the first energy harvesting current Ceh1 and the second energy harvesting current Ceh2, which are not rectified, respectively output from the first energy converter 610 and the second energy converter 620, the first auxiliary voltage Va1 output from the energy storage 630 may include noise, so that the first auxiliary voltage is rectified through the voltage stabilizer 640, which will be described below.

The energy storage 630 may have a smaller area than the source driver IC SD-IC and may be integrally configured with the source driver IC SD-IC on the source driver IC SD-IC. For example, the energy storage 630 may have a width less than or equal to that of the source driver IC SD-IC, and may have a length less than that of the source driver IC SD-IC. Accordingly, the source driver IC SD-IC and the energy harvesting apparatus 600 may be reduced in area and volume and light in weight.

The energy storage 630 includes a storage 631 and a switching part 632.

The storage 631 receives the first energy harvesting current Ceh1 converted from the thermal energy by the first energy converter 610 and the second energy harvesting current Ceh2 converted from the RF energy by the second energy converter 620, stores power, and outputs the first auxiliary voltage Va1 generated due to the stored power.

The switching part 632 controls the storage 631 to output the first auxiliary voltage Va1 to the voltage stabilizer 640 when the first auxiliary voltage Va1, which is a voltage generated due to the power stored in the storage 631, is greater than or equal to a usable voltage.

The voltage stabilizer 640 rectifies the first auxiliary voltage Va1 output from the energy storage 630 to output a second auxiliary voltage Va2. Specifically, since the energy storage 630 receives the first energy harvesting current Ceh1 and the second energy harvesting current Ceh2, which are not rectified, the first auxiliary voltage Va1 output from the energy storage 630 may include noise. Accordingly, the voltage stabilizer 640 rectifies the first auxiliary voltage Va1 output from the energy storage 630, and outputs the second auxiliary voltage Va2, which is obtained by rectifying the first auxiliary voltage Va1, to the source driver IC SD-IC.

Although not shown in the drawings, according to one embodiment of the present disclosure, the voltage stabilizer 640 may be disposed on the source driver IC SD-IC to be integrally configured with the source driver IC SD-IC. Accordingly, the energy harvesting apparatus 600 and the source driver IC SD-IC may be reduced in area and volume and light in weight.

Alternatively, according to another embodiment of the present disclosure, the voltage stabilizer 640 may be embedded in the source driver IC SD-IC. Accordingly, the energy harvesting apparatus 600 and the source driver IC SD-IC may be reduced in area and volume and light in weight.

Referring to FIG. 2 again, the voltage stabilizer 640 includes a bandgap reference voltage generator 641 and a regulator 642.

The bandgap reference voltage generator 641 generates a reference voltage Vref that maintains a constant level even when the temperature changes, and provides the reference voltage Vref to the regulator 642, which will be described below.

Since the voltage stabilizer 640 according to one embodiment of the present disclosure outputs the second auxiliary voltage Va2 using the reference voltage Vref generated by the bandgap reference voltage generator 641, the voltage stabilizer 640 may supply the second auxiliary voltage Va2 of a more stable level to the source driver IC SD-IC.

The regulator 642 outputs the second auxiliary voltage Va2 corresponding to the first auxiliary voltage Va1 to the source driver IC SD-IC using the reference voltage Vref generated from the bandgap reference voltage generator 641.

In the voltage stabilizer 640 according to one embodiment of the present disclosure, a DC-DC converter including an inductor is replaced with the bandgap reference voltage generator 641 and the regulator 642 so that power loss generated by the inductor of the DC-DC converter may be prevented, and complex analog circuits are replaced with the bandgap reference voltage generator 641 and the regulator 642, thereby reducing a circuit area of the voltage stabilizer 640.

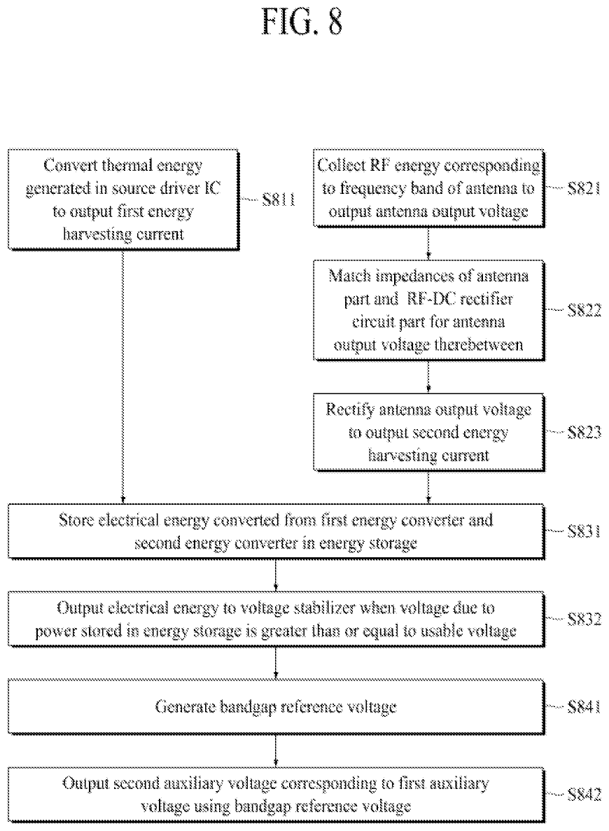

Hereinafter, an energy harvesting process of the energy harvesting apparatus and the display driving apparatus according to the present disclosure will be described in detail with reference to FIG. 8. FIG. 8 is a flowchart illustrating an energy harvesting process of the energy harvesting apparatus and the display driving apparatus according to one embodiment of the present disclosure.

Operation S811 is performed by the first energy converter 610, operations S821 to S823 are performed by the second energy converter 620, operations S831 and S832 are performed by the energy storage 630, and operations S841 and S842 are performed by the voltage stabilizer 640.

First, the energy harvesting apparatus 600 converts thermal energy generated in the source driver IC SD-IC to output a first energy harvesting current Ceh1 (S811).

Together with operation S811 described above, the energy harvesting apparatus 600 collects RF energy corresponding to a frequency band of the antenna to output an antenna output voltage to the impedance matching circuit part 622 (S821).

Thereafter, the energy harvesting apparatus 600 matches impedances of the antenna part 621 and the RF-DC rectifier circuit part 623 for the antenna output voltage therebetween in order to improve the reception efficiency of the RF energy (S822).

Thereafter, the energy harvesting apparatus 600 rectifies the antenna output voltage, which is an AC voltage, to output a second energy harvesting current Ceh2 to the energy storage 630 (S823).

Thereafter, the energy harvesting apparatus 600 stores electrical energy converted by the first energy converter 610 and the second energy converter 620 in the energy storage 630 (S831). Specifically, the energy harvesting apparatus 600 stores the first energy harvesting current Ceh1 converted from the thermal energy by the first energy converter 610 and the second energy harvesting current Ceh2 converted from the RF energy by the second energy converter 620 in the energy storage 630.

Thereafter, the energy harvesting apparatus 600 outputs the electrical energy stored in the energy storage 630 to the voltage stabilizer 640 when a voltage generated due to the amount of the power stored in the energy storage 630 is greater than or equal to a usable voltage (S832). Specifically, when a first auxiliary voltage Va1, which is a voltage generated due to the amount of the power stored in the energy storage 630, is greater than or equal to the usable voltage, the switching part 632 controls the storage 631 to output the stored power.

Thereafter, the energy harvesting apparatus 600 generates a reference voltage Vref that maintains a constant level even when the temperature changes (S841).

Thereafter, the energy harvesting apparatus 600 outputs a second auxiliary voltage Va2 corresponding to the first auxiliary voltage Va1 to the source driver IC SD-IC using the reference voltage Vref (S842).

An energy harvesting apparatus and a display driving apparatus including the same according to the present disclosure can reduce power consumed in the display driving apparatus by converting ambient thermal energy and RF energy into electrical energy and supplying the electrical energy to the display driving apparatus.

Further, an energy harvesting apparatus and a display driving apparatus including the same according to the present disclosure include an NMOS transistor having a high threshold voltage and low turn-on resistance, and a PMOS transistor having a low threshold voltage and high turn-on resistance, and thus can output a stable and high voltage as compared with an RF-DC rectifier circuit configured with only the NMOS transistor and an RF-DC rectifier circuit configured with only the PMOS transistor.

Further, an energy harvesting apparatus and a display driving apparatus including the same according to the present disclosure can prevent power loss caused by an inductor of a DC-DC converter by replacing the DC-DC converter including the inductor with a bandgap reference voltage generator and a regulator, and reduce a circuit area.

Further, in an energy harvesting apparatus and a display driving apparatus including the same according to the present disclosure, there is an effect that a first energy converter configured to convert thermal energy into electrical energy and a second energy converter configured to convert RF energy into electrical energy can be directly connected to one energy storage by including an RF-DC rectifier circuit part configured to rectify the electrical energy converted from the RF energy into direct current.

It will be apparent to those skilled in the art that various changes and modifications may be made without departing from the spirit and scope of the disclosure.

In addition, at least a part of the methods described herein may be implemented using one or more computer programs or components. These components may be provided as a series of computer instructions through a computer-readable medium or a machine-readable medium, which includes volatile and non-volatile memories. The instructions may be provided as software or firmware and may be entirely or partially implemented in a hardware configuration such as application specific integrated circuits (ASICs), field programmable gate arrays (FPGAs), digital signal processors (DSPs), or other similar devices. The instructions may be configured to be executed by one or more processors or other hardware components, and when one or more processors or other hardware components execute the series of computer instructions, one or more processors or other hardware components may entirely or partially perform the methods and procedures disclosed herein.

Therefore, it should be understood that the above-described embodiments are not restrictive but illustrative in all aspects. The scope of the present disclosure is defined by the appended claims rather than the detailed description, and it should be construed that all alternations or modifications derived from the meaning and scope of the appended claims and the equivalents thereof fall within the scope of the present disclosure.

### DESCRIPTION OF REFERENCE NUMERALS

10: display device
100: display panel
500: display driving apparatus
200: timing controller
300: data driver
400: gate driver

What is claimed is:

1. A display driving apparatus configured to drive a display device for displaying an image, the display driving apparatus comprising:
a source driver integrated circuit (IC) configured to convert image data into a source signal; and
an energy harvesting apparatus configured to convert thermal energy generated in the source driver IC and radio frequency (RF) energy into electrical energy and supply the electrical energy to the source driver IC,
wherein the energy harvesting apparatus includes:
a first energy converter configured to convert the thermal energy generated in the source driver IC into the electrical energy to output a first energy harvesting current;
a second energy converter configured to convert the RF energy into the electrical energy to output a second energy harvesting current; and
an energy storage configured to receive the first energy harvesting current and the second energy harvesting current from the first energy converter and the second energy converter, respectively, and store power to output a first auxiliary voltage that is a voltage generated due to the stored power, and
the first energy converter, the second energy converter, and the energy storage are located on the source driver IC.

2. The display driving apparatus of claim 1, further comprising a voltage stabilizer configured to output a second auxiliary voltage corresponding to the first auxiliary voltage to the source driver IC using a reference voltage that maintains a constant level in response to temperature changes.

3. The display driving apparatus of claim 1, further comprising a voltage stabilizer configured to output a second auxiliary voltage corresponding to the first auxiliary voltage to the source driver IC,
wherein the voltage stabilizer includes:
a bandgap reference voltage generator configured to output a reference voltage that maintains a constant level in response to temperature changes; and
a regulator configured to output the second auxiliary voltage of a constant level corresponding to the first auxiliary voltage to the source driver IC using the reference voltage.

4. The display driving apparatus of claim 1, further comprising a voltage stabilizer configured to output a second auxiliary voltage corresponding to the first auxiliary voltage to the source driver IC using a reference voltage that maintains a constant level in response to temperature changes,
wherein the voltage stabilizer is located on the source driver IC.

5. The display driving apparatus of claim 1, further comprising a voltage stabilizer configured to output a second auxiliary voltage corresponding to the first auxiliary voltage to the source driver IC using a reference voltage that maintains a constant level in response to temperature changes,
wherein the voltage stabilizer is embedded in the source driver IC.

6. The display driving apparatus of claim 1,
wherein the second energy converter includes:
an antenna part including an antenna configured to collect the RF energy and convert the collected RF energy to output an antenna output voltage; and
an RF-to-direct current (RF-DC) rectifier circuit part configured to rectify the antenna output voltage to output the second energy harvesting current.

7. The display driving apparatus of claim 1,
wherein the second energy converter includes:
an antenna part including an antenna configured to collect the RF energy and convert the collected RF energy to output an antenna output voltage; and
an RF-DC rectifier circuit part configured to receive a first antenna output voltage, which is the antenna output voltage, and a second antenna output voltage, which is an inverted voltage of the antenna output voltage, and rectify the first and second antenna output voltages using a first diode, which is an N-type metal-oxide-semiconductor (NMOS) transistor, a second diode, which is a P-type metal-oxide-semiconductor (PMOS) transistor, and a capacitor to output the second energy harvesting current.

8. The display driving apparatus of claim 1,
wherein the second energy converter includes:
an antenna part including an antenna configured to collect the RF energy and convert the collected RF energy to output an antenna output voltage; and
an RF-DC rectifier circuit part configured to receive a first antenna output voltage, which is the antenna output voltage, and a second antenna output voltage, which is an inverted voltage of the antenna output voltage, and rectify the first and second antenna output voltages using a first diode, which is an NMOS transistor, a second diode, which is a PMOS transistor, and two capacitors to output the second energy harvesting current,
wherein the RF-DC rectifier circuit part is configured by linearly connecting one or more unit rectifier circuits each including the first diode, the second diode, and the two capacitors.

9. The display driving apparatus of claim 1, wherein the energy storage outputs the first auxiliary voltage when the voltage generated due to the stored power is greater than or equal to a usable voltage.

10. The display driving apparatus of claim 1, wherein the first energy converter includes a plurality of thermoelectric modules in contact with the source driver IC to absorb the thermal energy generated in the source driver IC and configured to convert the absorbed thermal energy into the electrical energy.

11. The display driving apparatus of claim 1, wherein the first energy converter and the energy storage are provided in the form of a film.

12. A display driving method, comprising:
converting thermal energy generated from a source driver integrated circuit (IC) and radio frequency (RF) energy into electrical energy to output a first energy harvesting current and a second energy harvesting current;
receiving the first and second energy harvesting currents and storing power;
generating a first auxiliary voltage using the stored power; and
outputting a second auxiliary voltage corresponding to the first auxiliary voltage.

13. The display driving method of claim 12,
wherein the outputting of the second auxiliary voltage corresponding to the first auxiliary voltage includes:
outputting a reference voltage that maintains a constant level in response to temperature changes; and
outputting the second auxiliary voltage corresponding to the first auxiliary voltage using the reference voltage.

14. The display driving method of claim 12, wherein the converting of the thermal energy generated from the source driver IC and the RF energy to output the first and second energy harvesting currents includes converting the thermal energy generated from the source driver IC to output the first energy harvesting current.

15. The display driving method of claim 12,
wherein the converting of the thermal energy generated from the source driver IC and the RF energy into the electrical energy to output the first and second energy harvesting currents includes:
collecting the RF energy to output an antenna output voltage; and
rectifying the antenna output voltage to output the second energy harvesting current.

16. The display driving method of claim 12, wherein, in the generating of the first auxiliary voltage using the stored power, when a voltage corresponding to the stored power is greater than or equal to a usable voltage, the first auxiliary voltage is output.

17. The display driving method of claim 12, wherein, in the outputting of the second auxiliary voltage corresponding to the first auxiliary voltage, when a voltage corresponding to the stored power is greater than or equal to a usable voltage, the first auxiliary voltage is output.
